(19) United States
(12) Patent Application Publication
(10) Pub. No.: US 2023/0194460 A1
(43) Pub. Date: Jun. 22, 2023

(54) GAS SENSOR, SCANNING ELECTROCHEMICAL GAS MICROSCOPE, AND METHOD OF PREPARING GAS SENSOR

(71) Applicants: Samsung Electronics Co., Ltd., Suwon-si (KR); Industry-Academic Cooperation Foundation, Yonsei University, Seoul (KR)

(72) Inventors: Hyunpyo Lee, Seoul (KR); Hyun Seo Ahn, Seoul (KR); Suhyuk Choi, Seoul (KR); Jungock Park, Yongin-si (KR)

(21) Appl. No.: 17/816,547

(22) Filed: Aug. 1, 2022

(30) Foreign Application Priority Data
Dec. 22, 2021 (KR) 10-2021-0185412

(51) Int. Cl. G01N 27/404; G01N 27/413

(52) U.S. Cl. CPC G01N 27/404; G01N 27/413

(57) ABSTRACT

A gas sensor for measuring a gas content in an electrolyte, including: an at least partially closed capillary tube, including a first channel and a second channel separated by a septum; and a tip; a first electrode is located in the first channel, extends to an outer surface of the tip, and exposed on the outer surface of the tip; a second electrode is located in the second channel, extends to the outer surface of the tip, exposed on the outer surface of the tip, and spaced apart from the first electrode; an electrolyte in contact with the outer surface of the tip, in contact with the first electrode and the second electrode, and exposed to an outer surface of the gas sensor; a voltage source; and a current meter, wherein the electrolyte is not present in the first channel and the second channel.

### CROSS REFERENCE TO RELATED APPLICATION

This application is based on and claims priority to Korean Patent Application No. 10-2021-0185412, filed on Dec. 22, 2021, in the Korean Intellectual Property Office, and all the benefits accruing therefrom under 35 U.S.C. §119, the entire content of which is incorporated by reference herein.

### BACKGROUND

### 1. Field

The present subject matter relates to a gas sensor, a scanning electrochemical gas microscope, and a method of preparing a gas sensor.

### 2. Description of the Related Art

Recently, various gas sensors for detecting various gases have been used according to industrial requirements.

Optical gas sensors may measure with good accuracy and precision, have a long lifespan, and are generally stable, but are often prone to errors when operated in high humidity environments.

An electrochemical gas sensor may have a simple structure and excellent gas selectivity. An example of the electrochemical gas sensor may be a bulk-type electrochemical gas sensor. In the bulk-type electrochemical gas sensor, for example, a sensing electrode and a reference electrode may be disposed on one side of a ceramic solid electrolyte, and a high-temperature heater for sensor operation may be disposed on the other side. The bulk-type electrochemical gas sensor may require high temperatures, may be large in a size, and may consume large amounts of energy. It may be difficult to detect gas in a lower concentration range by using the bulk-type electrochemical gas sensor.

Accordingly, there remains a continuing need for gas sensors to overcome these and other limitations in the art.

### SUMMARY

According to an aspect, a gas sensor may have improved gas detection limit.

According to another aspect, a scanning electrochemical gas microscope may include the gas sensor.

According to another aspect, a method of preparing a gas sensor is provided.

Additional aspects will be set forth in part in the detailed description which follows and, in part, will be apparent from the detailed description, or may be learned by practice of the presented exemplary embodiments herein.

According to an aspect, a gas sensor for measuring a gas content in an electrolyte includes an at least partially closed capillary tube including a first channel; a second channel; and a tip, wherein the first channel and the second channel are separated by a septum, and, wherein the first channel and the second channel are closed by the tip, a first electrode that is located in the first channel, extends to an outer surface of the tip, and is exposed on the outer surface of the tip, a second electrode that is located in the second channel, extends to the outer surface of the tip, is exposed on the outer surface of the tip, and is spaced apart from the first electrode, an electrolyte that is in contact with the outer surface of the tip, is in contact with the first electrode and the second electrode, and is exposed to an outer surface of the gas sensor, a voltage source disposed between the first electrode and the second electrode, and a current meter disposed between the first electrode and the second electrode, wherein the electrolyte is not present in the first channel and the second channel.

According to another aspect, a scanning electrochemical gas microscope may include a sample, the gas sensor, and a scanning member that may scan a surface of the sample by the gas sensor according to a scan pattern.

According to still another aspect, a method of manufacturing a gas sensor may include preparing a theta capillary tube including a first channel and a second channel, wherein the first channel and the second channel are separated by a septum, placing a first electrode in the first channel and a second electrode in the second channel, applying energy on a center portion of the theta capillary tube while pulling both ends of the theta capillary tube in opposite directions to prepare an at least partially closed capillary tube, and contacting an electrolyte and a tip of the at least partially closed capillary tube, wherein the electrolyte is in contact with the first electrode and the second electrode, and is exposed to an outer surface of the gas sensor.

### BRIEF DESCRIPTION OF THE DRAWINGS

The above and other aspects, features, and advantages of certain exemplary embodiments will be more apparent from the following detailed description taken in conjunction with the accompanying drawings, in which:

FIG. 1 is a schematic view of one or more embodiments of a gas sensor;

FIG. 2 is a schematic view of one or more embodiments of a scanning electrochemical gas microscope;

FIG. 3 is a schematic diagram of one or more embodiments of a scanning electrochemical gas microscope;

FIG. 4 is a schematic view according to one or more aspects of a gas sensor spaced apart from an anode of a lithium-air battery;

FIG. 5 is a schematic view according to one or more aspects showing a mechanism of detecting oxygen on a surface of an anode of a lithium-air battery by a gas sensor;

FIGS. 6A to 6E show schematic views of one or more embodiments of a method of manufacturing a gas sensor;

FIG. 7 shows a scanning electron microscope (SEM) image of a tip prepared in Example 1; and

FIG. 8 is a graph of current (nanoamperes, nA) versus time (seconds, s) and shows a current profile according to time at various oxygen concentrations as measured by a gas sensor prepared in Example 1.

### DETAILED DESCRIPTION

Reference will now be made in further detail to exemplary embodiments, examples of which are illustrated in the accompanying drawings, wherein like reference numerals refer to like elements throughout. In this regard, the present exemplary embodiments may have different forms and should not be construed as being limited to the detailed descriptions set forth herein. Accordingly, the exemplary embodiments are merely described in further detail below, and by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept.

The terms used in the present specification are merely used to describe particular embodiments, and are not intended to limit the scope of the present subject matter. An expression used in the singular encompasses the expression of the plural, unless it has a clearly different meaning in the context. As used herein, the singular forms “a,” “an,” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It is to be understood that the terms such as “including”, “having,” or the like, are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. As used herein, “/” may be construed, depending on the context, as referring to “and” or “or”.

In the drawings, the thicknesses of layers and regions are exaggerated or reduced for clarity. Like reference numerals in the drawings and specification denote like elements. In the present specification, it will be understood that when an element, e.g., a layer, a film, a region, or a substrate, is referred to as being “on” or “above” another element, it can be directly on the other element or intervening layers may also be present. While such terms as “first”, “second”, or the like, may be used to describe various components, such components must not be limited to the above terms. The above terms are used only to distinguish one component from another. Throughout the specification and the drawings, like reference numerals refer to like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

It will be understood that when an element is referred to as being “on” another element, it can be directly in contact with the other element or intervening elements may be present therebetween. In contrast, when an element is referred to as being “directly on” another element, there are no intervening elements present.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present subject matter, and will not be interpreted in an idealized or overly formal sense unless expressly so defined herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ± 30%, 20%, 10%, 5% of the stated value.

As used herein, “metal” includes both metal and metalloid, such as silicon and germanium, in an elemental state or an ionic state.

As used herein, “alloy” refers to a mixture of two or more metals.

As used herein, “electrode active material” refers to an electrode material that may undergo lithiation and delithiation.

As used herein, “lithiation” refers to a process of adding lithium to an active material.

As used herein, “delithiation” refers to a process of removing lithium from an active material.

As used herein, “charging” refers to a process of providing electrochemical energy to a battery.

As used herein, “discharging” refers to a process of removing electrochemical energy from a battery.

As used herein, “anode” and “cathode” refer to electrodes where electrochemical reduction and lithiation may occur during a discharging process, respectively.

As used herein, “cathode” and “anode” refer to electrodes where electrochemical oxidation and delithiation may occur during a discharging process, respectively.

Hereinafter, a gas sensor according to one or more embodiments, a scanning electrochemical gas microscope, and a method of preparing a gas sensor will be described in further detail.

### Gas Sensor

According to an aspect, a gas sensor for measuring a gas content in an electrolyte includes: an at least partially closed capillary tube including: a first channel; a second channel; and a tip, wherein the first channel and the second channel are separated by a septum, wherein the first channel and the second channel are closed by the tip (for example, at least partially closed or fully closed); a first electrode that is located in the first channel, extends to an outer surface of the tip, and is exposed on the outer surface of the tip; a second electrode that is located in the second channel, extends to the outer surface of the tip, is exposed on the outer surface of the tip, and is spaced apart from the first electrode; an electrolyte that is in contact with the outer surface of the tip, is in contact with the first electrode and the second electrode, and is exposed to an outer surface of the gas sensor; a voltage source disposed between the first electrode and the second electrode; and a current meter disposed between the first electrode and the second electrode, wherein the electrolyte is not present in the first channel and the second channel. The at least partially closed capillary tube may be a partially closed capillary tube or a fully closed capillary tube.

The gas sensor does not contain an electrolyte inside the at least partially closed capillary tube. In other words, the electrolyte is not present in the first channel and the second channel. In addition, since the electrolyte is placed only in contact with (at or on) the tip of the gas sensor, the volume of the electrolyte used may become smaller, and the area of the electrode in contact with the electrolyte may also become smaller. Thus, the gas sensor may detect gas at a low concentration. For example, a limit of a gas concentration that the gas sensor may detect for a gas analyte or gas sample may be about 0.01 volume percent (vol%) or less, based on total volume of all gases, or about 100 parts per million (ppm) or less, based on the total volume of all gases. On the other hand, a gas sensor in the related art may essentially use a large area of an electrode and/or an excess of an electrolyte, thereby increasing a minimum gas content or amount required for the larger area of the electrode and/or the excess volume of the electrolyte. Thus, a lower limit of the gas concentration that a gas sensor in the related art may detect may be about 0.1 vol% or greater, based on total volume of all gases, or about 1,000 ppm or greater, based on total volume of all gases.

In the gas sensor described herein, the electrolyte is exposed to an outer surface of the gas sensor. In the gas sensor of described herein, the electrolyte may not be covered and/or impregnated with other membranes, such as a porous membrane. That is, the electrolyte is at an outermost surface of the gas sensor. In a gas sensor, it is possible to provide improved gas measurement sensitivity and reduced response time by not being additionally covered and/or impregnated with a porous membrane, such as a gas permeable membrane having a gas permeability and composition different from the electrolyte. In addition, the structure of the gas sensor may be simplified, and replacement of the electrolyte may become easy. On the other hand, a gas sensor in the related art may further include a gas permeable membrane covering the electrolyte, thereby reducing gas measurement sensitivity, and increasing response time.

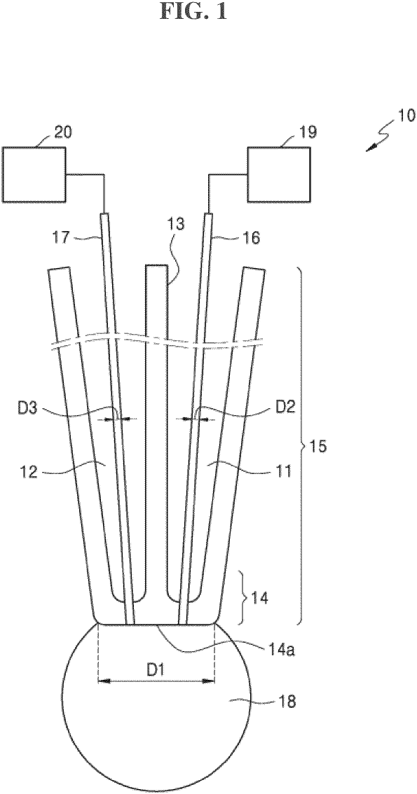

FIG. 1 is a schematic view of one or more embodiments of a gas sensor.

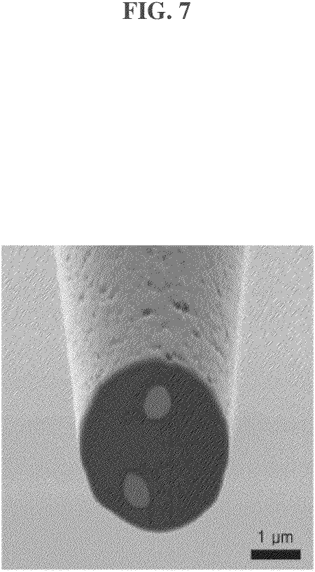

A gas sensor 10 for measuring a gas content in an electrolyte 18 includes: an at least partially closed capillary tube 15 including: a first channel 11 and a second channel 12 that may be separated by a septum 13; and a tip 14, wherein the first channel 11 and the second channel 12 are at least partially closed by or sealed in the tip 14; a first electrode 16 that is located in the first channel 11, extends to an outer surface 14a of the tip 14, and is exposed on the outer surface of the tip (a shown in FIG. 7); a second electrode 17 that is located in the second channel 12, extends to the outer surface 14a of the tip 14, is exposed on the surface of the tip (a shown in FIG. 7), and is spaced apart from the first electrode 16; an electrolyte 18 that is in contact with or located on the outer surface 14a of the tip 14, is in contact with the first electrode 16 and the second electrode 17, and is exposed to an outer surface of the gas sensor 10; a voltage source 19 disposed between the first electrode 16 and the second electrode 17; and a current meter 20 disposed between the first electrode 16 and the second electrode 17, wherein the electrolyte 18 is not present in the first channel 11 and the second channel 12.

The first electrode 16 may be, for example, a working electrode. The second electrode 17 may be, for example, a counter electrode and/or a reference electrode.

The voltage source 19 is disposed between the first electrode 16 and the second electrode 17. The voltage source 19 may be connected to the first electrode 16 and/or the second electrode 17. The voltage source 19, for example, may apply a constant voltage to the first electrode 16, a constant voltage to the second electrode 17, or a constant voltage to a space between the first electrode 16 and the second electrode 17. By applying a constant or time-varying potential to the first electrode 16 and/or second electrode 17 by the voltage source 19, an electrochemical reaction of a gas present in the electrolyte may be induced.

The current meter 20 is disposed between the first electrode 16 and the second electrode 17. The current meter 20 may be connected to the first electrode 16 and/or the second electrode 17. The current meter 20 may measure, for example, a current on the first electrode 16, a current on the second electrode 17, or a current on a space between the first electrode 16 and the second electrode 17. The current meter 20 may measure a current induced by an electrochemical reaction of gas present on a surface of the first electrode 16 and/or the second electrode 17.

The first electrode 16 and the second electrode 17 may be connected to, e.g., a potentiostat (not shown). The potentiostat may apply a constant voltage, for example, to the first electrode 16, the second electrode 17, or to a space between the first electrode 16 and the second electrode 17. The potentiostat may measure a current, for example, on the first electrode 16, on the second electrode 17, or on a space between the first electrode 16 and the second electrode 17. The potentiostat may serve as, for example, at least one of the voltage source 19 or the current meter 20.

The electrolyte 18 is in contact with at least a portion of the outer surface 14a of tip 14. The shape of the electrolyte 18 may be defined by, e.g., the shape of the tip 14 and by the surrounding atmosphere. The shape of the electrolyte 18 may be defined by, e.g., the outer surface 14a of the tip 14 and surrounding atmosphere. The electrolyte 18 may be, for example, in contact with the outer surface 14a of the tip 14 and may be surrounded by the surrounding atmosphere. The shape of the electrolyte 18 may be determined by the surrounding atmosphere except for at the tip 14. The surrounding atmosphere may not necessarily be air, and when environment to which the gas sensor 10 is applied, the surrounding atmosphere is not particularly limited if the surrounding atmosphere is a gas atmosphere such as an inert gas atmosphere. In some embodiments, the electrolyte 18, for example, does not additionally contact with a liquid and/or a solid. The electrolyte 18, for example, may not intentionally and additionally contact with a liquid and/or a solid, other than the tip 14. The electrolyte 18, for example, may contact only the tip 14 of the at least partially closed capillary tube 15 and may not additionally contact other porous membranes, gas permeable membranes, substrates, and sample solutions. As the electrolyte 18 may not be placed in the first channel 12 and the second channel 13 and may contact only the tip 14, a volume of the electrolyte 18 included in the gas sensor 10 may be significantly reduced. The gas sensor 10 may include the first electrode 11 and the second electrode 12, and the gas sensor 10 may be in additional contact with the electrolyte 18 at the outer surface 14a of the tip 14. Therefore, a microelectrochemical cell including the electrolyte 18, the first electrode 11, and the second electrode 12 may be configured. As a volume of the electrochemical cell may be significantly reduced, a lower limit to the concentration of gas that the electrochemical cell may detect may also be significantly decreased. Accordingly, a lower gas concentration and/or minimum gas content detectable by the gas sensor 10 may be significantly decreased. In other words, a sensitivity of the gas sensor 10 may be significantly increased.

A volume of the electrolyte 18 may be, for example, less than a volume of the at least partially closed capillary tube 15. The volume of the electrolyte 15 may be about 50% or less, about 20% or less, about 10% or less, about 5% or less, or about 1% or less of the volume of the at least partially closed capillary tube 15. The volume of the electrolyte 18 may be, for example, about 1 milliliter (mL) or less, about 0.1 mL or less, about 10 microliters (µL) or less, about 1 µL or less, about 0.1 µL or less, about 10 nanoliters (nL) or less, about 1 nL or less, about 0.1 nL, about 10 picoliters (pL) or less, about 1 pL or less, or about 0.1 pL or less. The volume of the electrolyte 18 may be in a range of, for example, about 1 femtoliter (fL) to about 1 mL, about 0.01 pL to about 1 mL, about 0.01 pL to about 0.1 mL, about 0.01 pL to about 0.01 mL, about 0.01 pL to about 1 µL, about 0.01 pL to about 0.1 µL, about 0.01 pL to about 0.01 µL, about 0.01 pL to about 1 nL, or about 0.01 pL to about 0.1 nL. The volume of the electrolyte 18 may be in a range of, for example, about 1 pL to about 1 mL, about 1 nL to about 0.1 mL, about 0.1 µL to about 0.1 mL, or about 1 µL to about 0.1 mL. As the electrolyte 18 may have a volume within any of these ranges, a volume of the electrochemical cell containing the electrolyte and a volume of the gas sensor 10 containing the electrochemical cell may be significantly reduced.

Tip 14 may be a protruding end of the at least partially closed capillary tube 15. A length of the tip 14 may be about 50% or less, about 10% or less, about 5% or less, about 3% or less, or about 1% or less of a total length of the at least partially closed capillary tube 15. The length of the tip 14 may be, for example, about 100 µm or less, about 50 µm or less, about 10 µm or less, about 6 µm or less, about 4 µm or less, about 3 µm or less, about 2 µm or less, or about 1 µm or less. The length of the tip 14 may be in a range of, for example, about 0.1 µm to about 100 µm, about 0.1 µm to about 50 µm, about 0.1 µm to about 10 µm, about 0.1 µm to about 6 µm, about 0.1 µm to about 4 µm, about 0.1 µm about to 3 µm, about 0.1 µm to about 2 µm, or about 0.1 µm to about 1 µm.

Referring now to FIG. 1, the diameter D1 of the tip 14 may be, for example, about 10 µm or less, about 6 µm or less, about 4 µm or less, about 3 µm or less, about 2 µm or less, or 1 µm or less. The diameter D1 of the tip 14 may be in a range of, for example, about 0.1 µm to about 10 µm, about 0.1 µm to about 6 µm, about 0.1 µm to about 4 µm, about 0.1 µm about to 3 µm, about 0.1 µm to about 2 µm, or about 0.1 µm to about 1 µm. When the tip 14 has a diameter within any of these ranges, the volume of the electrolyte 18 on tip 14 may be significantly reduced. Accordingly, a limit of a gas concentration that the gas sensor 10 may detect may be further increased. In addition, a resolution of the gas sensor 10 may be significantly improved. It is to be understood that the diameter D1 of the tip 14 represents an outer diameter of the at least partially closed capillary tube that is in contact with the electrolyte 18.

A diameter D2 of the first electrode 16 may be, for example, less than about 1 µm, about 500 nanometers (nm) or less, about 400 nm or less, about 300 nm or less, about 200 nm or less, or about 100 nm or less. The diameter D2 of the first electrode 16 may be in a range of, for example, about 10 nm to about 1 µm, about 10 nm to about 500 nm, about 10 nm to about 400 nm, about 10 nm to about 300 nm, about 10 nm to about 200 nm, or about 10 nm to about 100 nm. When the first electrode 16 has a diameter D2 within any of these ranges, the volume of the electrolyte 18 in contact with the first electrode 16 may be significantly reduced. Accordingly, a lower limit of a gas concentration that the gas sensor 10 may detect may be further increased.

A diameter D3 of the first electrode 17 may be, for example, less than about 1 µm, about 500 nm or less, about 400 nm or less, about 300 nm or less, about 200 nm or less, or about 100 nm or less. The diameter D3 of the second electrode 17 may be in a range of, for example, about 10 nm to about 1 µm, about 10 nm to about 500 nm, about 10 nm to about 400 nm, about 10 nm to about 300 nm, about 10 nm to about 200 nm, or about 10 nm to about 100 nm. When the second electrode 17 has a diameter D3 within any of these ranges, the volume of the electrolyte 18 in contact with the second electrode 17 may be significantly reduced. Accordingly, a lower limit of a gas concentration that the gas sensor 10 may detect may be further increased.

A distance between the first electrode 16 and the second electrode 17 on the outer surface 14a of the tip 14 may be, for example, less than 10 µm, 8 µm or less, 6 µm or less, 4 µm or less, 3 µm or less, 2 µm or less, or 1 µm or less. A distance between the first electrode 16 and the second electrode 17 on the outer surface 14a of the tip 14 may be in a range of, for example, about 0.1 µm to about 8 µm, about 0.1 µm to about 6 µm, about 0.1 µm to about 4 µm, about 0.1 µm about to 3 µm, about 0.1 µm to about 2 µm, or about 0.1 µm to about 1 µm. When a distance between the first electrode 16 and the second electrode 17 on the outer surface 14a of the tip 14 is within any of these ranges, the volume of the electrolyte 18 on tip 14 may be significantly reduced. Accordingly, a lower limit of a gas concentration that the gas sensor 10 may detect may be further increased. On the outer surface 14a of the tip 14, the distance between the first electrode 16 and the second electrode 17 may be the distance between the center of a surface of the first electrode 16 and the center of a surface of the second electrode 17.

The first electrode 16 and the second electrode 17 may each independently be, for example, a metal electrode or a carbon electrode. The first electrode 16 and the second electrode 17 may be, for example, inert to an electrochemical reaction.

The first electrode 16 and the second electrode 17 may each independently be, for example, platinum (Pt), gold (Au), tungsten (W), silver (Ag), copper (Cu), carbon (C), iron (Fe), aluminum (Al), or a combination thereof, but embodiments are not limited thereto, and any suitable electrode available in the art may be used. When the first electrode 16 and the second electrode 17 include these materials, durability of the gas sensor 10 may be improved. The carbon may be, for example, amorphous carbon or crystalline carbon.

The at least partially closed capillary tube 15 may further include a third channel (not shown). The at least partially closed capillary tube 15 may further include a third electrode (not shown). The third electrode may be located in the third channel and may extend to the outer surface 14a of the tip 14. The third electrode may be, for example, spaced apart from the first electrode 16 and the second electrode 17 on the outer surface 14a of the tip 14. When the at least partially closed capillary tube 15 further includes a third electrode (not shown), for example, the first electrode 16 may be a working electrode, the second electrode 17 may be a counter electrode, and the third electrode may be a reference electrode. When the at least partially closed capillary tube 15 further includes a third electrode (not shown), for example, the first electrode 16 may be a working electrode, the second electrode 17 may be a reference electrode, and the third electrode may be a counter electrode. For example, the first electrode 16, the second electrode 17, and the third electrode may be exposed on the outer surface 14a of the tip 14, and the first electrode 16, the second electrode 17, and the third electrode may be in contact with the electrolyte 18. Accordingly, an area of the outer surface 14a of the tip 14 including the first electrode 16, the second electrode 17, and the third electrode may be significantly reduced, as compared with the surface area of an electrode included in a gas sensor in the related art. The gas sensor 10 may measure a concentration of gas present in the electrolyte 18 by a method such as a change in current according to time at a constant voltage or a change in current according to a change in potential. The gas sensor 10 may measure a concentration of gas present in the electrolyte by, for example, a chronoamperometry that measures a current over time after applying a step potential or a cyclo voltammetry that measures a current while scanning a potential at a constant rate according to time.

The electrolyte 18 may be, for example, a liquid electrolyte, a gel electrolyte, a solid electrolyte, or a combination thereof. The electrolyte 18 may not contain a silane compound or a reaction product thereof.

The term “liquid” as used herein refers to a state of matter having a fixed volume at room temperature but not being fixed in shape at room temperature. The term “liquid” also means a state of matter in which a shape is determined according to the surrounding conditions in contact with the liquid. A liquid may flow at room temperature.

The term “liquid electrolyte” as used herein refers to an electrolyte that may have an ionic conductivity and may have a fixed volume at room temperature but not be fixed in shape at room temperature. A “liquid electrolyte” means an electrolyte in which a shape is determined according to the surrounding conditions in contact with the liquid electrolyte. A liquid electrolyte may flow at room temperature.

The term “solid” as used herein refers to a state of matter having a fixed volume at room temperature and having a fixed rigid shape at room temperature. A solid may not flow at room temperature.

The term “solid electrolyte” as used herein refers to an electrolyte that may have an ionic conductivity and may have a fixed volume at room temperature and have a fixed shape at room temperature. A solid electrolyte may be an electrolyte that may have a fixed shape at room temperature and may not flow at room temperature. A “solid electrolyte” means an electrolyte that intentionally may not contain a “solvent” such as water or an organic solvent (i.e., a nonionic low-molecular substance that is liquid at room temperature). A “solid electrolyte” may include an electrolyte in which a solvent is substantially removed by drying or the like, even when a solvent such as an organic solvent is used in a manufacturing process. An ionic liquid is not a “solvent” herein, because an ionic liquid is an ionic low-molecular substance that is liquid at room temperature.

The term “gel” as used herein refers to a state of matter containing a liquid at room temperature but moving like a solid by a three-dimensional cross-linked network in the liquid.

The term “gel electrolyte” as used herein refers to an electrolyte that may have an ionic conductivity and may contain a liquid at room temperature but move like a solid at room temperature.

The electrolyte 18 may be, for example, an electrolyte liquid drop or an electrolyte film.

As used herein, an “electrolyte liquid drop” is a liquid electrolyte in a form of a drop or droplet. An electrolyte liquid drop may have, for example, a shape similar to a spherical shape, such as a semi-spherical shape or a hemispherical shape. An electrolyte liquid drop may have, for example, a shape of the electrolyte 18 shown in FIG. 1. An electrolyte liquid drop may have, for example, a hemispherical shape.

As used herein, an “electrolyte film” may be, for example, a thin film. The shape of an electrolyte film may be, for example, square, rectangular, circular, or the like, but is not limited thereto. The shape may be selected according to the required shape of the tip. A diameter of the electrolyte film may be, for example, similar to a diameter D1 of the tip 14. A diameter of the electrolyte film may be in a range of, for example, about 90% to about 110% of the diameter D1 of the tip 14. A thickness of the electrolyte film may be in a range of, for example, about 1% to about 300%, or about 10% to about 300% of the diameter D1 of the tip 14. The electrolyte film may be, for example, a self-standing film.

The electrolyte 18 may include, for example, an aqueous solvent, an organic solvent, an ionic liquid, an ionic liquid polymer, an ion conductive polymer, a matrix polymer, or a combination thereof.

The electrolyte 18 may include, for example, a solvent. The solvent may include, for example, a solvent such as an aqueous solvent or an organic solvent. An aqueous solvent may be, for example, water or an alcohol. An alcohol may be methanol, ethanol, propanol, butanol, or a combination thereof. The organic solvent may be, for example, a carbonate compound, a glyme compound, a dioxolane compound, or a combination thereof. A carbonate compound may be, for example, ethylene carbonate, propylene carbonate, dimethyl carbonate, fluoroethylene carbonate, diethyl carbonate, ethylmethyl carbonate, or a combination thereof. A glyme compound may be, for example, poly(ethylene glycol) dimethyl ether (PEGDME; polyglyme), diethylene glycol dimethyl ether (diglyme), dimethylene glycol dimethyl ether, trimethylene glycol dimethyl ether, tetraethylene glycol dimethyl ether (TEGDME; tetraglyme), triethylene glycol dimethyl ether (triglyme), poly(ethylene glycol) dilaurate (PEGDL), polyethylene glycol) monoacrylate (PEGMA), poly(ethylene glycol) diacrylate (PEGDA), or a combination thereof. A dioxolane compound may be, for example, 3-dioxolane, 4,5-diethyl-1,3-dioxolane, 4,5-dimethyl-1,3-dioxolane, 4-methyl-1,3-dioxolane, 4-ethyl-1,3-dioxolane, or a combination thereof. Examples of the organic solvent include 2,2-dimethoxy-2-phenyl acetophenone, dimethyl ether (DME), 1,2-dimethoxyethane, 1,2-diethoxyethane, tetrahydrofuran (THF), γ-butyrolactone, 1,1,2,2-tetrafluoroethyl 2,2,3,3-tetrafluoropropyl ether, or a combination thereof. The organic solvent may be, for example, ethylene carbonate, propylene carbonate, dimethyl carbonate, diethyl carbonate, ethylmethyl carbonate, fluoroethylene carbonate, γ-butyrolactone, dimethoxyethane, diethoxyethane, dimethylene glycol dimethylether, trimethylene glycol dimethylether, tetraethylene glycol dimethylether, polyethylene glycol dimethylether, succinonitrile, sulfolane, dimethyl sulfone, ethylmethyl sulfone, diethyl sulfone, adiponitrile, 1,1,2,2-tetrafluoroethyl 2,2,3,3-tetrafluoropropyl ether, or a combination thereof.

A solvent included in the electrolyte 18 may be, for example, liquid at room temperature. The vapor pressure of the solvent contained in the electrolyte 18 may be about 1 atmosphere (atm) or less, about 0.5 atm or less, about 0.2 atm or less, about 0.1 atm or less, about 0.05 atm or less, or about 0.01 atm or less at 25° C. The boiling point of the solvent may be about 50° C. or greater, 70° C. or greater, 100° C. or greater, 120° C. or greater, or 150° C. or greater. The molecular weight of the solvent contained in the electrolyte 18 may be, for example, about 500 Daltons or less, about 400 Daltons or less, about 300 Daltons or less, about 200 Daltons or less, or about 100 Daltons or less.

The electrolyte 18 may include, for example, an ionic liquid. As used herein, the term “ionic liquid” refers to a salt in a liquid state at room temperature or a room temperature molten salt having a melting point of room temperature or less and consisting of ions.

The ionic liquid may be, for example, represented by Formula 1 or Formula 2:

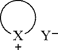

wherein, in Formula 1,

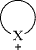

indicates a C2-C30 ring having 3 atoms to 31 atoms and having at least one heteroatom, which may be a cycloalkyl ring or a heteroaryl ring, and

X may be ═N(R₁), ═P(R₁), ═N(R₁)(R₂), or ═P(R₁)(R₂), and Y- may be an anion,

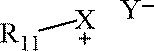

wherein, in Formula 2,
X may be —N(R₁)(R₂)(R₃) or —P(R₁)(R₂)(R₃),
R₁ to R₃ may each independently be hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxy group,
R₁₁ may be hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxy group, and
Y⁻ may be an anion.

For example, the moiety represented by:

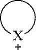

in Formula 1 of the solid electrolyte may be represented by Formula 3, and the moiety represented by

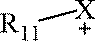

in Formula 2 may be a cation represented by Formula 4:

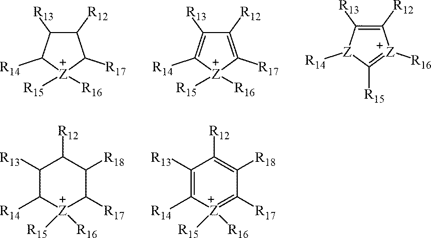

wherein, in Formula 3,
Z may be N or P, and
R₁₂ to R₁₈ may each independently be hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxy group,

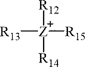

wherein, in Formula 4,
Z may be N or P, and
R₁₂ to R₁₅ may each independently be hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxy group.

The ionic liquid may be, for example, a compound including: a) at least one cation that may be an ammonium cation, a pyrrolidinium cation, a pyridinium cation, a pyrimidinium cation, an imidazolium cation, a piperidinium cation, a pyrazolium cation, an oxazolium cation, a pyridazinium cation, a phosphonium cation, a sulfonium cation, a triazolium cation, or a combination thereof; and b) at least one anion that may be BF₄^{—}, PF₆^{—}, AsF₆^{—}, SbF₆^{—}, AlCl₄^{—}, HSO₄^{—}, ClO₄^{—}, CH₃SO₃^{—}, CF₃CO₂^{—}, Cl^{—}, Br^{—}, I^{—}, BF₄^{—}, SO₄^{—}, CF₃SO₃^{—} (OTf^{—}), (FSO₂)₂N^{—}, (C₂F₅SO₂)₂N^{—}, (C₂F₅SO₂)(CF₃SO₂)N^{—}, (CF₃SO₂)₂N⁻ (NTf₂⁻), or a combination thereof.

The ionic liquid may be, for example, ethyl methyl imidazolium chloride/AlCl₃ ([emim]Cl/AlCl₃), butyl methyl pyridinium bis(trifluoromethanesulfonyl)amide ([bmpyr]NTf₂), 4,4′-bipyridine bromide/AlCl₃ ([bpy]Br/AlCl₃), [choline]Cl/CrCl₃O 6H₂O, propane-bis(N-hexyl-pyridinium) di(bis(trifluoromethanesulfonylimide)) [Hpy(CH₂)₃pyH][NTf₂]₂, ethyl methyl imidazolium trifluoromethanesulfonate/hexyl methyl imidazolium iodide ([emim]OTf/[hmim]I), [choline]Cl/HOCH₂CH₂OH, [Et₂MeN(CH₂CH₂OMe)]BF₄ (Et is ethyl, Me is methyl), [Bu₃PCH₂CH₂CsF₁₇]OTf (OTf is trifluoromethane sulfonate, Bu is butyl), [bmim]PF₆ (bmim is butyl methyl imidazolium), [bmim]BF₄, [omim]PF₆ (omim is octyl methyl imidazolium), [Oct₃PC₁₈H₃₇]I (Oct is octyl), [NC(CH₂)₃mim]NTf₂ (mim is methyl imidazolium), [Pr₄N][B(CN)₄], [bmim]NTf₂ (Pr is propyl), [bmim]Cl, [bmim][Me(OCH₂CH₂)₂OSO₃], [PhCH₂mim]OTf (Ph is phenyl), [Me₃NCH(Me)CH(OH)Ph]NTf₂, [pmim][(HO)₂PO₂] (pmim is propyl methyl imidazolium), [(6-Me)bquin]NTf₂ (bquin is butyl quinolinium), [bmim][Cu₂Cl₃], [C₁₈H₃₇OCH₂mim]BF₄ (mim=methyl imidazolium), [heim]PF₆ (heim is hexyl ethyl imidazolium), [mim(CH₂CH₂O)₂CH₂CH₂mim][NTf₂]₂ (mim is methyl imidazolium), [obim]PF₆ (obim is octyl butyl imidazolium), [oquin]NTf₂ (oquin is octyl quinolinium), [hmim][PF₃(C₂F₅)₃], [C₁₄H₂₉mim]Br, [Me₂N(C₁₂H₂₅)₂]NO₃, [emim]BF₄, [mm(3-NO₂)im][dinitrotriazolate], [MeN(CH₂CH₂OH)₃], [MeOSO₃], [Hex₃PC₁₄H₂₉]NTf₂, [emim][EtOSO₃], [choline][ibuprofenate], [emim]NTf₂, [emim][(EtO)₂PO₂], [emim]Cl/CrCl₂, [Hex₃PC₁₄H_{29]}N(CN)₂, or a combination thereof.

Unless specified otherwise, mim is methyl imidazolium, emim is ethyl methyl imidazolium, hmim is hexyl methyl imidazolium, obim is octyl butyl imidazolium, bmim is butyl methyl imidazolium, omim is octyl methyl imidazolium, pmim is propyl methyl imidazolium, bppyr is butyl methyl pyridinium, bpy is 4,4′-bipyridine, Et is ethyl, Me is methyl, Pr is propyl, Bu is butyl, Ph is phenyl, Oct is octyl, Hex is hexyl, py is pyridine, obim is octyl butyl imidazolium, bquin is butyl quinolinium, heim is hexyl ethyl imidazolium, oquin is octyl quinolinium, OTf is trifluoromethane sulfonate, and NTf₂ is bis(trifluoromethanesulfonyl)imide.

The ionic liquid may be, for example, N-methyl-N-propyl pyrrolidinium, bis(trifluoromethane sulfonyl)imide, N-butyl-N-methylpyrrolidinium bis(3-trifluoromethane sulfonyl)imide, 1-butyl-3-methylimidazolium bis(trifluoromethyl sulfonyl)amide, 1-ethyl-3-methyl imidazolium bis(trifluoromethylsulfonyl)amide, N,N-diethyl-N-methyl-N-(2-methoxyethyl) ammonium tetraborate ([DEME][BF₄]), diethylmethyl ammonium trifluoromethane sulfonate ([dema][OTf]), dimethylpropyl ammonium trifluoromethane sulfonate ([dmpa][OTf]), diethylmethyl ammonium trifluoromethane sulfonyl imide ([DEME][TFSI]), methylpropyl piperidinium trifluoromethane sulfonyl imide ([mpp][TFSI]), or a combination thereof.

The electrolyte 18 may include, for example, an ionic liquid polymer, an ion conductive polymer, a matrix polymer, or a combination thereof.

The ionic liquid polymer which may be added to the protective film-forming composition may be, for example, a polymerization product of ionic liquid monomers, or a polymeric compound. The ionic liquid polymer may have high solubility for an organic solvent and further improve ion conductivity of the electrolyte.

When the ionic liquid polymer is prepared by polymerization of ionic liquid monomers, a resulting product from the polymerization reaction may be washed and dried, followed by an anionic substitution reaction to have appropriate anions that may improve solubility in an organic solvent.

The polymer ionic liquid may include a repeating unit including a) at least one cation that is an ammonium cation, a pyrrolidinium cation, a pyridinium cation, a pyrimidinium cation, an imidazolium cation, a piperidinium cation, a pyrazolium cation, an oxazolium cation, a pyridazinium cation, a phosphonium cation, a sulfonium cation, a triazolium cation, or a combination thereof; and b) at least one anion that is BF₄^{—}, PF₆^{—}, AsF₆^{—}, SbF₆^{—}, AlCl₄^{—}, HSO₄^{—}, ClO₄^{—}, CH₃SO₃^{—}, CF₃CO₂^{—}, (CF₃SO₂)₂N^{—}, (FSO₂)₂N^{—}, Cl^{—}, Br^{—}, I^{—}, SO₄^{—}, CF₃SO₃^{—}, (C₂F₅SO₂)₂N^{—}, (C₂F₅SO₂)(CF₃SO₂)N^{—}, NO₃^{—}, Al₂Cl₇^{—}, (CF₃SO₂)₃C^{—}, (CF₃)₂PF₄^{—}, (CF₃)₃PF₃^{—}, (CF₃)₄PF₂^{—}, (CF₃)₅PF^{—}, (CF₃)₆P^{—}, SF₅CF₂SO₃^{—}, SF₅CHFCF₂SO₃^{—}, CF₃CF₂(CF₃)₂CO^{—}, CF₃SO₂)₂CH^{—}, (SF₅)₃C^{—}, (O(CF₃)₂C₂(CF₃)₂O)₂PO^{—}, or a combination thereof.

The ionic liquid monomer used in preparing the polymer ionic liquid may have a functional group that is polymerizable with a vinyl group, an allyl group, an acrylate group, or a methacrylate group and have at least one cation that is an ammonium cation, a pyrrolidinium cation, a pyridinium cation, a pyrimidinium cation, an imidazolium cation, a piperidinium cation, a pyrazolium cation, an oxazolium cation, a pyridazinium cation, a phosphonium cation, a sulfonium cation, a triazolium cation, or a combination thereof, and further includes a corresponding anion.

Examples of the ionic liquid monomer include 1-vinyl-3-ethylimidazolium bromide, and a compound represented by Formula 5 or Formula 6:

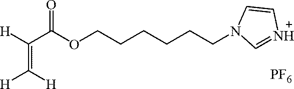

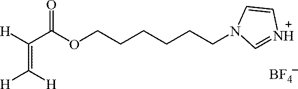

For example, the ionic liquid polymer may be a compound represented by Formula 7 or a compound represented by Formula 8:

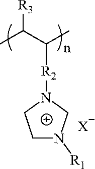

wherein, in Formula 7,
R₁ and R₃ may each independently be hydrogen, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₆-C₃₀ aryl group, a substituted or unsubstituted C₂-C₃₀ heteroaryl group, a substituted or unsubstituted C₄–C₃₀ carbocyclic group,
R₂ may be a single bond, a C₁-C₃ alkylene group, a C₆-C₃₀ arylene group, a C₂-C₃₀ heteroarylene group, or a C₄-C₃₀ carbocyclic group,
X⁻ may be an anion of an ionic liquid, and
n may be in a range of about 500 to about 2,800,

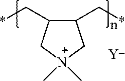

wherein, in Formula 8,
Y⁻ is defined the same as X⁻ in Formula 9, and
n may be in a range of about 500 to about 2,800.

In Formula 8, Y⁻ may be, for example, bis(trifluoromethanesulfonyl)imide (TFSI), BF₄, or CF₃SO₃.

The ionic liquid polymer may include, for example, a cation that is poly(1-vinyl-3-alkylimidazolium), poly(1-allyl-3-alkylimidazolium), or poly(1-(methacryloxy-3-alkylimidazolium), and an anion that is CH₃COO^{—}, CF₃COO^{—}, CH₃SO₃^{—}, CF₃SO₃^{—}, (CF₃SO₂)₂N^{—}, (FSO₂)₂N^{—}, (CF₃SO₂)₃C^{—}, (CF₃CF₂SO₂)₂N^{—}, C₄F₉SO₃^{—}, C₃F₇COO^{—}, or (CF₃SO₂)(CF₃CO)N⁻.

The ionic liquid polymer represented by Formula 8 may be, for example, poly(diallyldimethylammonium bis(trifluoromethanesulfonyl)imide).

The ion conductive polymer may be a polymer having an ionic conductivity. The ion conductive polymer may include an ion dissociative functional group, an ion dissociative functional group substituted with alkali metal, or a combination thereof. The ion dissociative functional group may be, for example, —C(═O)OH, —OS(═O)₂OH, —S(═O)₂OH, —S(═O)OH, —OP(═O)O₂H, —P(═O)O₂H, or a combination thereof. The ion dissociative functional group substituted with alkali metal may be, for example, —C(═O)OM, —OS(═O)₂OM, —S(═O)₂OM, —S(═O)OM, —OP(═O)O₂M, —P(═O)O₂M, or a combination thereof (wherein M may be Li, Na, K, Rb, or Cs). The ion conductive polymer may be, for example, poly(acrylic acid), poly(methacrylic acid), poly(maleic acid), poly(ethylene-alt-maleic acid), poly(isobutylene-alt-maleic acid), poly(butadiene-co-maleic acid), poly(methylvinylether-alt-maleic acid), poly(vinylether-alt-maleic acid), poly(2-acrylamido-2-methyl-1-propane sulfonate), poly(styrene sulfonic acid), carboxymethyl cellulose, alginate, polysulfonate fluoropolymer, alkali metal-substituted poly(acrylic acid), alkali metal-substituted poly(methacrylic acid), alkali metal-substituted poly(maleic acid), alkali metal-substituted poly(ethylene-alt-maleic acid), alkali metal-substituted poly(butadiene-co-maleic acid), alkali metal-substituted poly(methylvinyl ether-alt-maleic acid), alkali metal-substituted poly(vinyl ether-alt-maleic acid), alkali metal-substituted poly(2-acrylamido-2-methyl-1-propane sulfonate), alkali metal-substituted poly(styrene sulfonate), alkali metal-substituted carboxymethyl cellulose, alkali metal-substituted alginate, alkali metal-substituted polysulfonate fluoropolymer, or a combination thereof. The alkali metal may be, for example, lithium, rubidium, cesium, or a combination thereof. The ion conductive polymer may be, for example, Nafion.

The matrix polymer may maintain an electrolyte film shape. The matrix polymer may be, for example, polyethylene, polypropylene, poly(tetrafluoroethylene) (PTFE), poly(vinylidene fluoride) (PVdF), styrene-butadiene rubber, tetrafluoroethylene-perfluoro alkylvinylether copolymer, vinylidene fluoride-chlorotrifluoroethylene copolymer, ethylene-tetrafluoroethylene copolymer, poly(chlorotrifluoroethylene), vinylidene fluoride-pentafluoro propylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinylether-tetrafluoroethylene copolymer, poly(acrylonitrile), or a combination thereof.

The electrolyte 18 may include a salt. The salt may be an alkali metal salt. The salt may be, for example, LiCl, NaCl, KCl, RbCl, CsCl, or a combination thereof but embodiments are not limited thereto. Any suitable salt used as a dissociable salt in the art may be used. A concentration of a salt included in the electrolyte 18 may be, for example, in a range of about 1 millimolar (mM) to about 10 molar (M) .

The electrolyte 18 may be gas permeable. The electrolyte 18 may be soluble to gas. Thus, gas may pass through the electrolyte 18 to contact the first electrode 16 and/or the second electrode 17 and to cause an electrochemical reaction. In addition, a reaction product produced when the gas reacts with a compound present in the electrolyte 18 may cause an electrochemical reaction.

The gas that the gas sensor 10 may detect (i.e., the gas analyte) may include, but is not necessarily limited to, for example, oxygen (O₂), carbon dioxide (CO₂), carbon monoxide (CO), sulfur dioxide (SO₂), nitrogen dioxide (NO₂), hydrogen (H₂), methane (CH₄), hydrogen fluoride (HF), or a combination thereof. Any suitable gas that may participate in an electrochemical reaction available in the art may be used.

A content of the gas analyte detectable by the gas sensor 10 may be, for example, about 0.0014 vol% or greater, about 0.002 vol% or greater, about 0.005 vol% or greater, or about 0.01 vol% or greater, based on a total volume of gas. A content of the gas analyte detectable by the gas sensor 10 may be, for example, in a range of about 0.0014 vol% to about 10 vol%, about 0.002 vol% to about 5 vol%, about 0.005 vol% to about 1 vol%, or about 0.01 vol% to about 0.1 vol%, based on a total volume of gas. That is, the gas content is in the percentage of the volume occupied by the gas analyte to be detected in the total volume of a gas sample.

The at least partially closed capillary tube 15 may be, for example, glass, quartz, or the like, but is not necessarily limited thereto, and any suitable material that is insulative and durable may be used.

### Scanning Electrochemical Gas Microscope

A scanning electrochemical gas microscope according to an aspect may include: a sample; the gas sensor as described above; and a scanning member that may scan a surface of the sample by the gas sensor according to a scan pattern.

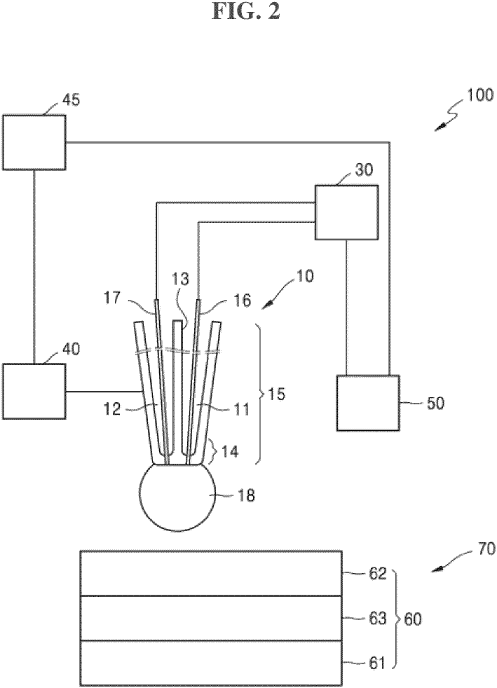

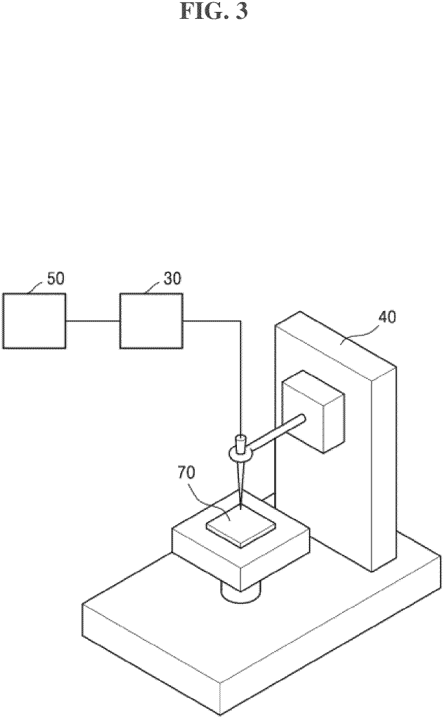

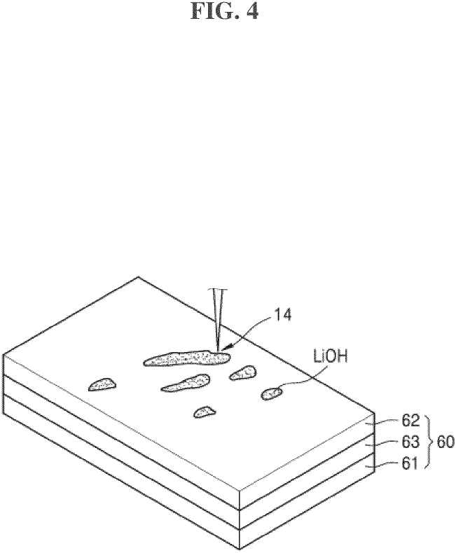

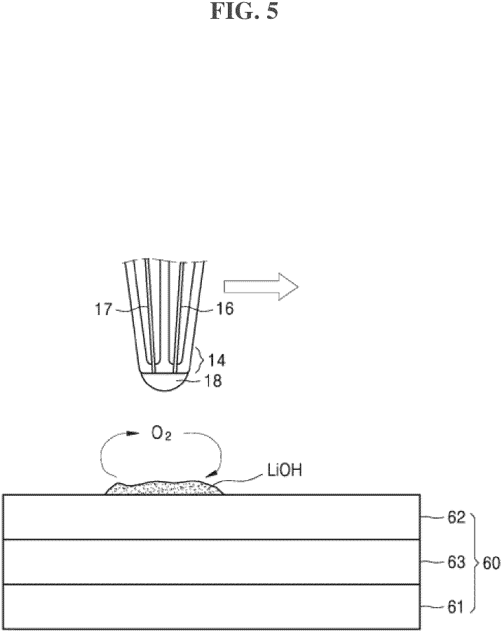

FIG. 2 is a schematic view of one or more embodiments of a scanning electrochemical gas microscope. FIG. 3 is a schematic diagram of one or more embodiments of a scanning electrochemical gas microscope. FIG. 4 is a schematic view of a gas sensor spaced apart from an anode of a lithium-air battery. FIG. 5 is a schematic view showing a mechanism of detecting oxygen on a surface of an anode of a lithium-air battery by a gas sensor.

In FIG. 2, the scanning electrochemical gas microscope 100 may include a sample 70; the gas sensor 10, and a scanning member 40 that may scan a surface of the sample 70 by the gas sensor 10 according to a scan pattern.

The gas sensor 10 may be connected to a controller 50 through a potentiostat 30. The controller, for example, may be a personal computer. In some embodiments, the controller 50 may be between the potentiostat 30 and the personal computer as a separate member distinct from a computer.

The potentiostat 30 may be set to apply a constant voltage to the first electrode 16 or to apply a constant voltage to a space between the first electrode 16 and the second electrode 17. The potentiostat 30 may be set to measure a current flowing on the first electrode 16, the second electrode 17, or between the first electrode 16 and the second electrode 17 by an electrochemical reaction. The potentiostat 30 may serve as at least one of a current meter and a voltage source.

The scanning member 40 may scan the at least partially closed capillary tube 15 on a surface of the sample 70 according to a constant scan pattern. The relative position of the at least partially closed capillary tube 15 on the surface of the sample 70 may be determined by the scanning member 40. The scanning member 40 may be, for example, an x-axis, y-axis, and z-axis piezoelectric positioner. The position of the piezoelectric positioner 40 with respect to the position of the sample may be controlled by an x-axis, y-axis, and z-axis manipulator screw such as a microscrew. The scanning member 40 may be controlled by a piezoelectric controller 45. The piezoelectric controller 45 may be connected to a controller 50. According to the scan pattern input to the controller 50, the scanning member 40, that is, the piezoelectric positioner, may determine the relative position of the at least partially closed capillary tube 15 on the surface of the sample 70 over time by the scanning member 45. According to a gas concentration present on a surface of the sample 70, the gas sensor 10 may measure a local gas concentration through the electrolyte 18. The at least partially closed capillary tube 15, for example, may implement conformal mapping conforming to a surface contour of the sample 70.

The scanning electrochemical gas microscope 100 may further include, for example, an image acquisition member that may be electrically connected to the gas sensor 10 and may collect a profile image of a gas concentration on a surface of the sample 70 (not shown).

For example, the image acquisition member (not shown) may collect gas concentration data measured according to a scan pattern of the at least partially closed capillary tube 15 on a surface of the sample 70 and may show imported data in a form of a two-dimensional or three-dimensional profile. For example, the image acquisition member may image the gas concentration data according to the position of the tip 14 placed at the end of the at least partially closed capillary tube 15 in a form of a two-dimensional or three-dimensional profile, such as a contour line. For example, a two-dimensional or three-dimensional gas concentration profile may be displayed on a computer monitor. As the scanning electrochemical gas microscope 100 may include an image acquisition member, distribution of a gas concentration on a surface of a sample may be easily understood. As a diameter D1 of the tip 14 included in the gas sensor 10 may be about 10 µm or less, a resolution of the scanning electrochemical gas microscope 100 may be about 10 µm or less. In the scanning electrochemical gas microscope 100, when a diameter D1 of the tip 14 included in the gas sensor 10 is about 2 µm, the two-dimensional gas concentration profile to be collected may have a resolution of about 2 µm. Therefore, by adjusting a diameter D1 of the tip 14 to about 1 µm or less, a resolution of a gas concentration on a surface of a sample may be improved to about 1 µm or less. As a result, by using the scanning electrochemical gas microscope 100, gas concentration mapping may be realized to have a high resolution of less than about 1 µm on a surface of a sample.

The gas sensor 10 may include the electrolyte 18, and the electrolyte 18 may be spaced apart from the sample 70. As the electrolyte 18 may be separated from a sample, the gas sensor according to one or more embodiments may be distinguished from a microscope in the related art in which the electrolyte 18 is in contact with a sample. In addition, as the electrolyte 18 may be separated from the sample, it is possible to effectively analyze the gas concentration distribution on a surface of the sample with only a very small amount of the electrolyte 18. A distance at which the electrolyte 18 may be separated from sample 70 may be selected according to the required resolution. A distance between a lower surface of the electrolyte 18 and an upper surface of the sample 70 may be, for example, about 100 µm or less, about 50 µm or less, about 10 µm or less, about 5 µm or less, or about 2 µm or less. A distance between a lower surface of the electrolyte 18 and an upper surface of the sample 70 may be in a range of, for example, about 0.1 µm to about 100 µm, about 0.1 µm to about 50 µm, about 0.1 µm to about 10 µm, about 0.1 µm to about 5 µm, or about 0.1 µm to about 2 µm. It is to be understood that the “lower surface” of the electrolyte 18 is a surface closest to the “upper surface” of the sample 70.

A content of the gas analyte detectable by the gas sensor 10 on a surface of the sample 70 may be, for example, about 0.0014 vol% or greater, about 0.002 vol% or greater, about 0.005 vol% or greater, or about 0.01 vol% or greater, based on a total volume of gas sample. A content of the gas analyte detectable by the gas sensor 10 may be, for example, in a range of about 0.0014 vol% to about 10 vol%, about 0.002 vol% to about 5 vol%, about 0.005 vol% to about 1 vol%, or about 0.01 vol% to about 0.1 vol%, based on a total volume of gas sample. The gas content is in the percentage of the volume occupied by the gas analyte to be detected in the total volume of a gas sample. The gas concentration distribution on a surface of the sample 70 may be precisely analyzed, because the gas sensor 10 may have such an improved gas detection limit.

The sample may be, for example, an electrochemical battery 60. The electrochemical battery 60 may be, for example, a metal-air battery. The metal-air battery may be, for example, a lithium-air battery. The metal-air battery 60 may include, for example, an anode 62, a cathode 61, and an electrolyte layer 63 between the anode 63 and the cathode 61. The lithium-air battery 60 may use an aqueous electrolyte and an organic electrolyte as the electrolyte, and when an aqueous electrolyte is used, the aqueous electrolyte may exhibit a reaction mechanism as in Reaction Scheme 1:

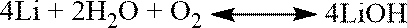

During discharging cycles, lithium from the cathode 61 may meet oxygen introduced from the anode 62 to generate lithium hydroxide, and oxygen may be reduced (oxygen reduction reaction (ORR)). In addition, during charging cycles, lithium hydroxide may be reduced, and the oxygen atom may be oxidized (oxygen evolution reaction (OER)). During discharging, LiOH or the like may be precipitated in pores of the anode, and a capacity of the lithium-air battery 60 may increase as a concentration of oxygen diffused into the anode 63 increases. Upon charging of the metal-air battery 60, oxygen may be released from a surface of the anode 62, and upon discharging, oxygen may be used as an electrode active material on a surface of the anode 62. Therefore, upon charging of the metal-air battery 60, by scanning a surface of the anode 62 with the scanning electrochemical gas microscope 100, oxygen concentration distribution on the surface of the anode 62 may be analyzed with high resolution.

### Method of Manufacturing Gas Sensor

A method of manufacturing a gas sensor includes: preparing a theta capillary tube including a first channel and a second channel, wherein the first channel and the second channel are separated by a septum; placing a first electrode in the first channel and a second electrode in the second channel; applying energy to a center portion of the theta capillary tube while pulling both ends of the theta capillary tube in opposite directions to prepare an at least partially closed capillary tube; and contacting an electrolyte and a tip of the at least partially closed capillary tube, wherein the electrolyte is in contact with the first electrode and the second electrode, and is exposed to an outer surface of the gas sensor.

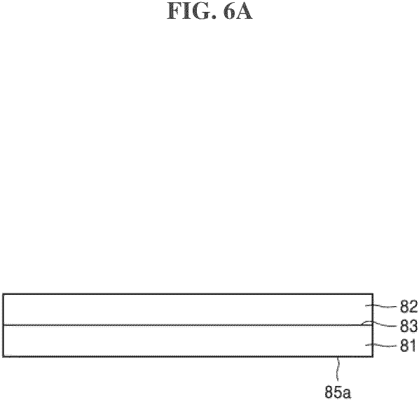

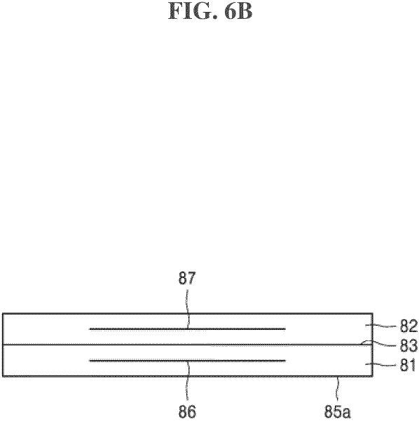

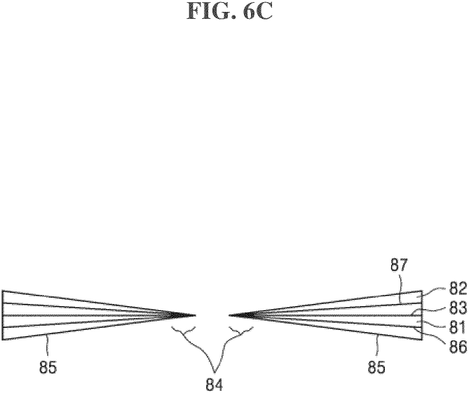

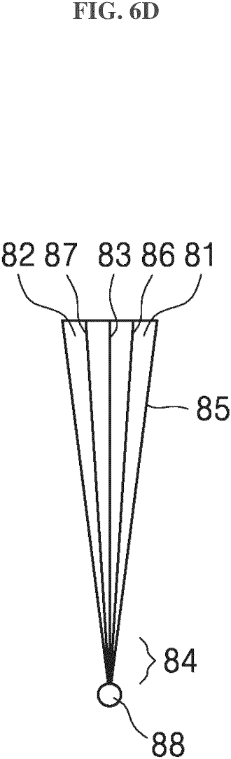

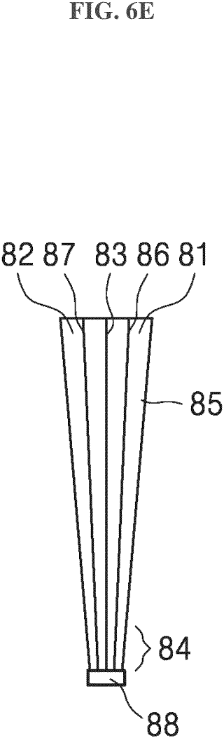

FIGS. 6A to 6E show schematic views of one or more embodiments of a method of manufacturing a gas sensor.

First, a theta capillary tube 85a including a first channel 81 and a second channel 82 separated by a septum 83 may be prepared. A diameter of the first channel 81 and the second channel 82 may each independently be in a range of, for example, about 10 nm to about 100 µm, about 10 nm to about 50 µm, about 10 nm to about 10 µm, about 10 nm to about 5 µm , about 10 nm to about 3 µm , or about 10 nm to about 1 µm. An outer diameter of the theta capillary tube 85a may be, for example, 500 µm to 10 mm, 100 µm to 5 mm, or 100 µm to 2 mm. An inner diameter of the theta capillary tube 85a may be, for example, 10 µm to 5 mm, 50 µm to 3 mm, 100 µm to 1 mm, or 100 µm to 0.5 mm. A thickness of the septum 83 may be, for example, 10 µm to 1 mm, 50 µm to 1 mm, 100 µm to 1 mm, or 100 µm to 0.5 mm. The theta capillary tube 85a may be glass or quartz. It is to be understood that the diameter of the first channel represents an inner diameter of the first channel, and that the diameter of the second channel represents an inner diameter of the second channel.

Then, the first electrode 86 may be placed in a center region of the first channel 81, and the second electrode 87 may be placed in a center region of the second channel 82. The first electrode 86 and the second electrode 87 may be nanofibers, nanowires, microfibers, or microwires. A diameter of the first electrode 86 and the second electrode 87 may be, for example, about 10 nm to about 900 nm, about 10 nm to about 500 nm, about 10 nm to about 400 nm, about 10 nm to about 300 nm, about 10 nm to about 200 nm, or about 10 nm to about 100 nm. The first electrode 16 and the second electrode 17 may each independently be, for example, platinum (Pt) wires, gold (Au) wires, silver (Ag) wires, copper (Cu) wires, or carbon wires. The carbon wires may be carbon fibers.

Then, energy is applied on a center portion of the theta capillary tube 85a while pulling both ends of the theta capillary tube 85a in opposite directions to prepare an at least partially closed capillary tube 85. Both ends of the theta capillary tube 85a may be pulled in opposite directions while applying laser to a center thereof using a laser puller. The laser may be, for example, a pulsed laser. The center portion of the theta capillary tube 85a may be gradually stretched and thinned by the laser, and finally separated to thereby obtain the at least partially closed capillary tube 85. During the stretching and separating, one end of the theta capillary tube 85a may be at least partially closed to obtain the at least partially closed capillary tube 85. The tip 14 may be formed at one end of the at least partially closed capillary tube. The tip may be formed by, for example, polishing or cutting one end of the at least partially closed capillary tube 85. A diameter, shape, or the like of the tip may be selected according to required conditions.

Then, an electrolyte 88 is placed in contact with a tip 84 of the at least partially closed capillary tube 85. For example, after impregnating the closed capillary tube 85 with the electrolyte, the at least partially closed capillary tube 85 may be taken out to place the electrolyte 88 in a form of a liquid drop on the tip 84. In some embodiments, the electrolyte 88 may be placed by attaching an electrolyte thin film to the tip 84 of the at least partially closed capillary tube 85. On the other hand, the electrolyte 88 is not placed in the first channel 81 and the second channel 82 of the at least partially closed capillary tube 85. The manufacture of a gas sensor may be completed by connecting each end of the first electrode 86 and the second electrode 88 to a potentiostat and/or to a controller with a wire. As a volume of the electrolyte 88 attached to the tip 84 and the tip 84 included in the gas sensor are small, it is possible to precisely measure the gas concentration in a narrow area.

As used herein, a substituent may be derived by substitution of at least one hydrogen atom in an unsubstituted mother group with another atom or a functional group. Unless stated otherwise, a substituted functional group refers to a functional group substituted with at least one substituent that is a C₁-C₄₀ alkyl group, a C₂-C₄₀ alkenyl group, a C₂-C₄₀ alkynyl group, a C₃-C₄₀ cycloalkyl group, a C₃-C₄₀ cycloalkenyl group, or a C₇-C₄₀ aryl group. When a functional group is “optionally” substituted, it means that the functional group may be substituted with such a substituent as listed above.

a and b in the term “Cₐ—C_{b}” as used herein refer to the number of carbon atoms in a particular functional group. That is, a functional group may include from a to b carbon atoms. For example, “C₁ to C₄ alkyl group” as used herein refers to an alkyl group having 1 to 4 carbon atoms, i.e., CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

As used herein, a particular radical group or substituent may refer to a mono-radical or a di-radical depending on the context. For example, when a substituent needs two binding sites to bind with the rest of the molecule, the substituent may be understood as a di-radical. For example, a substituent of an alkyl group that needs two binding sites may include a di-radical such as —CH_{2—}, —CH₂CH_{2—}, or —CH₂CH(CH₃)CH_{2—}. The term “alkylene” clearly indicates that the radical is a di-radical.

The term “alkyl group” or “alkylene group” as used herein refers to a branched or unbranched aliphatic hydrocarbon group. In some embodiments, an alkyl group may be substituted or unsubstituted. Non-limiting examples of the alkyl group may include a methyl group, an ethyl group, a propyl group, an iso-propyl group, a butyl group, an isobutyl group, a tert-butyl group, a pentyl group, a hexyl group, a cyclopropyl group, a cyclopentyl group, a cyclohexyl group, a cycloheptyl group, or a combination thereof, each of which may optionally be substituted or unsubstituted. In some embodiments, an alkyl group may have 1 to 6 carbon atoms. Non-limiting examples of a C₁-C₆ alkyl group include a methyl group, an ethyl group, a propyl group, an isopropyl group, a butyl group, an isobutyl group, a sec-butyl group, a pentyl group, a 3-pentyl group, and a hexyl group.

The term “alkoxy group” as used herein refers to an “—O— alkyl group”, and the alkyl group is the same as described above. Non-limiting examples of the alkoxy group may include methoxy, ethoxy, propoxy, 2-propoxy, butoxy, tert-butoxy, pentyloxy, hexyloxy, cyclopropoxy, or cyclohexyloxy, but embodiments are not limited thereto. At least one hydrogen atom of the alkoxy group may be substituted with the same substituents as used in the alkyl group described above.

The term “alkyleneoxy group” as used herein refers to an “—O— alkylene group”, and the alkylene group is the same as described above. Non-limiting examples of the alkyleneoxy group may include a methylene oxide group, an ethylene oxide group, or a propylene oxide group, but embodiments are not limited thereto. At least one hydrogen atom of the alkyleneoxy group may be substituted with the same substituents as used in the alkyl group described above.

The term “alkenyl group” as used herein refers to a hydrocarbon group including 2 to 20 carbon atoms with at least one carbon-carbon double bond. Examples of the alkenyl group include an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexenyl group, or a cycloheptenyl group, but embodiments are not limited thereto. At least one hydrogen atom of the alkenyl group may be substituted with the same substituents as used in the alkyl group described above. In some embodiments, an alkenyl group may have 2 to 40 carbon atoms.

The term “alkynyl group” as used herein refers to a hydrocarbon group including 2 to 20 carbon atoms with at least one carbon-carbon triple bond. For example, the alkynyl group may include an ethynyl group, a 1-propynyl group, a 1-butynyl group, or a 2-butynyl group, but embodiments are not limited thereto. At least one hydrogen atom of the alkynyl group may be substituted with the same substituents as used in the alkyl group described above. In some embodiments, an alkynyl group may have 2 to 40 carbon atoms.

The term “cycloalkyl group” as used herein refers to a carbocyclic ring or ring system that is fully saturated. For example, the cycloalkyl group may include a cyclopropyl group, a cyclobutyl group, a cyclopentyl group, or a cyclohexyl group, but embodiments are not limited thereto. At least one hydrogen atom of the cycloalkyl group may be substituted with the same substituents as used in the alkyl group described above.

The term “heterocycloalkyl group” as used herein refers to a carbocyclic ring or ring system that is fully saturated and including at least one heteroatom as a ring atom instead of carbon. For example, the heterocycloalkyl group may include a pyrrolidinyl group, but embodiments are not limited thereto. For example, the heteroatom may include at least one of phosphorus (P), oxygen (O), sulfur (S), silicon (Si), selenium (Se), boron (B), germanium (Ge), or nitrogen (N), but embodiments are not limited thereto.

The term “aromatic” as used herein refers to a ring or ring system having a conjugated pi electron system. For example, an “aromatic group” may include a carbon ring aromatic group (e.g., a phenyl group) and a heterocyclic aromatic group (e.g., a pyridine). For example, an aromatic ring system as a whole may include a single ring or a fused polycyclic ring (i.e., a ring that shares adjacent atom pairs).

The term “aryl group” as used herein refers to an aromatic ring or ring system (i.e., a ring fused from at least two rings, which shares two or more adjacent carbon atoms) of at least two rings including only carbon atoms in the ring, or a plurality of aromatic rings that are linked to each other via a single bond, —O—, —S—, —C(═O)—, —S(═O)₂—, —Si(Rₐ)(R_{b})—(wherein Rₐ and R_{b} may each independently be a C₁-C₁₀ alkyl group), a C₁-C₁₀ alkylene group substituted or unsubstituted with a halogen, or —C(═O)—NH—. When the aryl group is a ring system, each ring in the ring system may be aromatic. Non-limiting examples of the aryl group include a phenyl group, a biphenyl group, a naphthyl group, a phenanthrenyl group, or a naphthacenyl group. In some embodiments, an aryl group may be substituted or unsubstituted. At least one hydrogen atom of the aryl group may be substituted with the same substituents as used in the alkyl group described above.

The term “aryloxy group” as used herein may be represented by —O—aryl. Examples thereof may include a phenoxy group. At least one hydrogen atom of the aryloxy group may be substituted with the same substituents as used in the alkyl group described above.

The term “arylene group” as used herein refers to an aryl group that needs at least two binding sites (i.e., is at least divalent). A tetravalent arylene group is an aryl group that needs four binding sites. A divalent arylene group is an aryl group that needs two binding sites. For example, a divalent arylene group may be —C₆H₅—O—C₆H₅—. At least one hydrogen atom of the arylene group may be substituted with the same substituents as used in the alkyl group described above.

The term “heteroaryl group” as used herein refers to an aromatic ring system wherein a ring, a plurality of fused rings, or a plurality rings that are linked to each other via a single bond, —O—, —S—, —C(═O)—, —S(═O)₂—, —Si(Rₐ)(R_{b})— (wherein Rₐ and R_{b} may each independently be a C₁-C₁₀ alkyl group), a C₁-C₁₀ alkylene group substituted or unsubstituted with a halogen, or —C(═O)—NH—, wherein at least one ring-forming atom is not carbon, i.e., is a heteroatom. In the fused ring system, at least one heteroatom may be in one of the rings. In the fused ring system, at least one heteroatom may be in one of the rings. For example, the heteroatom may include at least one of phosphorus (P), oxygen (O), sulfur (S), silicon (Si), selenium (Se), boron (B), germanium (Ge), or nitrogen (N), but embodiments are not limited thereto. Non-limiting examples of the heteroaryl group include a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, or an indolyl group. At least one hydrogen atom of the heteroaryl group may be substituted with the same substituents as used in the alkyl group described above.

Examples of the monocyclic heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “heteroaryl group” as used herein also includes a group having a heteroaromatic ring fused to at least one aryl, cycloaliphatic, or heterocyclic ring.

Examples of a bicyclic heteroaryl group may include an indolyl group, an isoindolyl group, an indazolyl group, an indolizinyl group, a purinyl group, a quinolizinyl group, a quinolinyl group, an isoquinolinyl group, a cinnolinyl group, a phthalazinyl group, a naphthyridinyl group, a quinazolinyl group, a quinoxalinyl (quinolo[4,3-d]pyridinyl) group, a pyrazolo[4,3-c]pyridinyl group, a pyrazolo[3,4-c]pyridinyl group, a pyrazolo[3,4-d]pyridinyl group, a pyrazolo[3,4-b]pyridinyl group, an imidazo[1,2-a]pyridinyl group, a pyrazolo[1,5-a]pyridinyl group, a pyrrolo[1,2-b]pyridazinyl group, an imidazo[1,2-c]pyrimidinyl group, a pyrido[3,2-d]pyrimidinyl group, a pyrido[4,3-d]pyrimidinyl group, a pyrido[3,4-d]pyrimidinyl group, a pyrido[2,3-d]pyrimidinyl group, a pyrido[2,3-b]pyrazinyl group, a pyrido[3,4-b]pyrazinyl group, a pyrimido[5,4-d]pyrimidinyl group, a pyrazino[2,3-b]pyrazinyl group, or a pyrimido[4,5-d]pyrimidinyl group.

The term “heteroaryloxy group” as used herein may be represented by —O—heteroaryl. Examples thereof may include a pyridinyloxy group. At least one hydrogen atom of the heteroaryloxy group may be substituted with the same substituents as used in the alkyl group described above.

The term “heteroarylene group” as used herein refers to a heteroarylene group that needs at least two binding sites (i.e., has a valency of at least two). A tetravalent heteroarylene group is a heteroaryl group that needs four binding sites. A divalent heteroarylene group is a heteroaryl group that needs two binding sites. At least one hydrogen atom of the heteroarylene group may be substituted with the same substituents as used in the alkyl group described above.

The term “arylalkyl group” as used herein refers to an aryl group linked to a substituent via an alkylene group, for example, a C₇-C₁₄ arylalkyl group. At least one hydrogen atom of the arylalkyl group may be substituted with the same substituents as used in the alkyl group described above.

The term “alkylaryl group” as used herein refers to an aryl group substituted with at least one alkyl group. At least one hydrogen atom of the alkylaryl group may be substituted with the same substituents as used in the alkyl group described above.

The term “cycloalkenyl group” as used herein refers to a non-aromatic carbocyclic ring or ring system with at least one double bond. For example, the cycloalkenyl group may be a cyclohexenyl group. At least one hydrogen atom of the cycloalkenyl group may be substituted with the same substituents as used in the alkyl group described above.

The term “heterocyclic group” as used herein refers to a non-aromatic ring or ring system including at least one heteroatom in its ring system. At least one hydrogen atom of the heterocyclic group may be substituted with the same substituents as used in the alkyl group described above.

The term “halogen” as used herein refers to a stable atom belonging to Group 17 of the periodic table of elements, for example, fluorine, chlorine, bromine, or iodine. For example, the halogen atom may be fluorine and/or chlorine.

Hereinafter the inventive concept will be described in further detail with reference to Examples and Comparative Examples. These examples are for illustrative purposes only and are not intended to limit the scope of the inventive concept.

### EXAMPLES

### Manufacture of Gas Sensor

### Example 1

A theta glass capillary tube having a septum of 0.2 mm, an inner diameter of 0.3 mm, and an outer diameter of 2 mm was prepared. The theta glass capillary tube included a first channel and a second channel that are separated by the septum.

In the theta glass capillary tube, a first electrode of a platinum (Pt) nanowire having a diameter of 400 nm was placed in the first channel, second an electrode of a silver (Ag) nanowire having a diameter of 400 nm was placed in the second channel.

An at least partially closed capillary tube having a dual channel was manufactured by pulling the theta glass capillary tube while applying a pulsed laser to the center of the theta glass capillary tube by using a laser puller.

The tip of the at least partially closed capillary tube was polished to form a tip having a diameter of about 3 µm.

The surface of the tip is shown in FIG. 7. As shown in FIG. 7, the first channel and the second channel were closed by the tip. The first electrode and the second electrode were exposed on the outer surface of the tip.

That is, the first electrode and the second electrode were each sealed by a glass at the end of the capillary tube and extended to the outer surface of the tip.

Copper wires were put into the first channel and the second channel, each of the first electrode and the second electrode was back-contacted with the copper wires, and each of the copper wires was connected to a potentiostat.

After putting the tip into the ionic liquid electrolyte, the tip was taken out to thereby place the ionic liquid electrolyte on the outer surface of the tip to prepare a gas sensor.

The ionic liquid electrolyte was attached to the outer surface of the tip in the form of a liquid drop. The volume of the ionic liquid electrolyte attached to the outer surface of the tip was 6 × 10⁻⁸ µL.

The ionic liquid was N-propyl-N-methylpyrrolidinium bis(fluorosulfonyl)imide (PYR13FSI) represented by Formula 9:

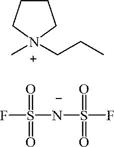

### Preparation Example 1: Manufacture of Lithium-Air Battery

### Manufacture of Anode

Li_{0.34}La_{0.55}RuO₃ (hereinafter, referred to as “LLRuO”) was ball-milled for pulverization to thereby obtain a powder having a particle size (D50) of about 300 nm. The obtained lithium-containing metal oxide powder, a binder, i.e., a polyvinyl butyral resin (BUTVAR B79, available from Eastman), a dispersant (DISPERBYK111, available from BYK-Chemie GmbH), and a plasticizer (di-n-butyl phthalate, available from DBP) were mixed at a weight ratio of 100:10:5:5, followed by adding ethanol as a solvent and mixing, thereby obtaining a slurry. The prepared slurry was coated on a release film using a doctor blade to a thickness of 200 µm and then dried in the air for 12 hours, followed by drying for 12 hours in a vacuum oven at 60° C., to prepare a coating layer. The prepared coating layer was cut to a size of 7×7 square millimeters (mm²) on a release film. Then, the two cut coating layers were stacked to face each other and hot-pressed at 250 pounds per square inch (psi) at 100° C. for 15 minutes for lamination. Then, the release film was removed therefrom to thereby obtain a green sheet. The obtained green sheet was heat-treated in an atmospheric atmosphere at 600° C. for 2 hours, followed by heat-treating at 1,100° C. for 6 hours, to manufacture a porous self-standing film.

### Manufacture of Lithium-Air Battery

A separator (CELGARD 3501) was placed on a lithium metal foil cathode.

A cathode interlayer was prepared by injecting 0.2 mL of an electrolyte in which 1 M lithium bis(trifluoromethanesulfonyl)imide (LiTFSI) was dissolved in propylene carbonate (PC) to the separator.

A lithium-aluminum titanium phosphate (LATP) solid electrolyte film (having a thickness of 250 µm, available from Ohara Corp., Japan) was placed on the separator to prepare a substructure of anode/anode interlayer/solid electrolyte layer.

The substructure was covered with an aluminum coated pouch on polyolefin. By installing a window of a certain size at the top of the pouch, the LATP solid electrolyte was exposed to the outside of the pouch.

The anode prepared above was placed on the LATP solid electrolyte exposed outside the pouch. For gas analysis, a Pt mesh was placed and fixed on the side of the anode, and the anode current collector was connected to the anode.

### Evaluation Example 1: Gas Detection Limit Evaluation

The gas sensor manufactured in Example 1 was placed in a chamber including a gas inlet and a gas outlet.

An at least partially closed capillary tube was placed in the chamber, and a copper wire connected to the first and second electrodes was connected to a potentiostat.

A constant voltage was applied between the first electrode and the second electrode while flowing nitrogen gas containing oxygen (O₂) into the chamber, and the current according to time was measured.

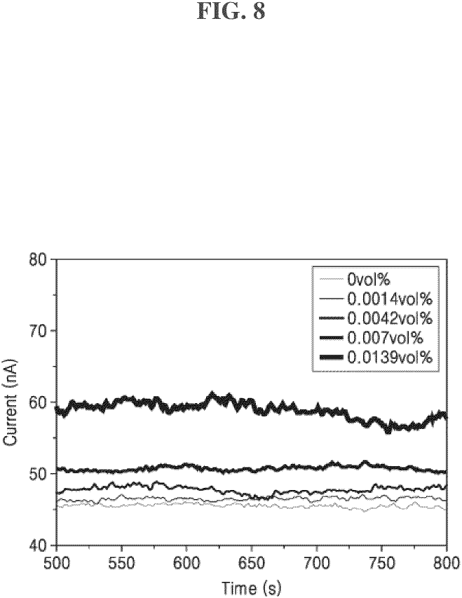

While changing the content of oxygen (O₂) contained in the supplied nitrogen gas, the current according to the oxygen content was measured and shown in FIG. 8. The bottom in FIG. 8 shows a current profile according to time when oxygen was not included.

As shown in FIG. 8, it was confirmed that the amount of current increased in cases of the oxygen content of 0.0139 vol%, 0.007 vol%, 0.0042 vol%, and 0.0014 vol%, as compared with a case where oxygen was not included.

Therefore, it was confirmed that by using the gas sensor manufactured in Example 1, it was possible to detect even a very low oxygen content of 0.0014 vol%.

### Evaluation Example 2: Measurement of Oxygen Concentration on Surface of Anode in Metal-Air Battery

The gas sensor manufactured in Example 1 was placed on the anode of the metal-air battery manufactured in Preparation Example 1.

By using the gas sensor, it was confirmed that the oxygen concentration on the outer surface of the anode increased during the charging process of the metal-air battery.

Therefore, it was confirmed that the two-dimensional profile of oxygen concentration emitted from the surface of the metal-air battery anode may be measured using a gas sensor.

As described above, the all-solid secondary battery according to one or more embodiments may be applied to various portable devices or vehicles.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments. While one or more exemplary embodiments have been described with reference to the figures, it will be understood by those of ordinary skill in the art that various changes in form and details may be made therein without departing from the spirit and scope as defined by the following claims.

What is claimed is:

1. A gas sensor for measuring a gas content in an electrolyte, the gas sensor comprising:
an at least partially closed capillary tube, comprising:
a first channel;
a second channel; and
a tip,
wherein the first channel and the second channel are separated by a septum, and
wherein the first channel and the second channel are closed by the tip;
a first electrode that is located in the first channel, extends to an outer surface of the tip, and is exposed on the outer surface of the tip;
a second electrode that is located in the second channel, extends to the outer surface of the tip, is exposed on the outer surface of the tip, and is spaced apart from the first electrode;
an electrolyte that is in contact with the outer surface of the tip, is in contact with the first electrode and the second electrode, and is exposed to an outer surface of the gas sensor;
a voltage source disposed between the first electrode and the second electrode; and
a current meter disposed between the first electrode and the second electrode,
wherein the electrolyte is not present in the first channel and the second channel.

2. The gas sensor of claim 1, wherein a shape of the electrolyte is defined by the tip and a surrounding atmosphere.

3. The gas sensor of claim 1, wherein
a volume of the electrolyte is less than a volume of the at least partially closed capillary tube, and
the volume of the electrolyte is about 1 milliliter or less.

4. The gas sensor of claim 1, wherein an outer diameter of the tip is about 10 micrometers or less.

5. The gas sensor of claim 1, wherein a diameter of the first electrode and a diameter of the second electrode are each independently less than about 1 micrometer.

6. The gas sensor of claim 1, wherein a distance between the first electrode and the second electrode on the outer surface of the tip is less than about 10 micrometers.

7. The gas sensor of claim 1, wherein the first electrode and the second electrode each independently comprises platinum (Pt), gold (Au), tungsten (W), silver (Ag), copper (Cu), carbon (C), iron (Fe), aluminum (Al), or a combination thereof.

8. The gas sensor of claim 1, wherein the at least partially closed capillary tube further comprises:
a third channel; and
a third electrode that is located in the third channel, extends to the outer surface of the tip, and is spaced apart from the first electrode and the second electrode.

9. The gas sensor of claim 1, wherein the electrolyte is a liquid, a gel, or a solid.

10. The gas sensor of claim 1, wherein the electrolyte is an electrolyte liquid drop or an electrolyte film.

11. The gas sensor of claim 1, wherein the electrolyte comprises an aqueous solvent, an organic solvent, an ionic liquid, an ionic liquid polymer, an ion conductive polymer, a matrix polymer, or a combination thereof.

12. The gas sensor of claim 1, wherein the electrolyte comprises a salt.

13. The gas sensor of claim 1, wherein the electrolyte is gas permeable.

14. The gas sensor of claim 1, wherein the gas comprises oxygen (O₂), carbon dioxide (CO₂), carbon monoxide (CO), sulfur dioxide (SO₂), nitrogen dioxide (NO₂), hydrogen (H₂), methane (CH₄), hydrogen fluoride (HF), or a combination thereof.

15. A scanning electrochemical gas microscope, comprising:
a sample;
the gas sensor according to claim 1; and
a scanning member that scans a surface of the sample by the gas sensor according to a scan pattern.

16. The scanning electrochemical gas microscope of claim 15, wherein the scanning electrochemical gas microscope comprises an image acquisition member that is electrically connected to the gas sensor and acquires a gas concentration profile image of the surface of the sample.

17. The scanning electrochemical gas microscope of claim 15, wherein the gas sensor comprises an electrolyte, and the electrolyte is spaced apart from the sample.

18. The scanning electrochemical gas microscope of claim 15, wherein a gas content on the outer surface of the sample detected by the gas sensor is 0.0014 percent by volume or greater.

19. The scanning electrochemical gas microscope of claim 15, wherein the sample is a metal-air battery.

20. A method of manufacturing a gas sensor, the method comprising:
preparing a theta capillary tube comprising a first channel and a second channel, wherein the first channel and the second channel are separated by a septum;
placing a first electrode in the first channel and a second electrode in the second channel;
applying energy on a center portion of the theta capillary tube while pulling both ends of the theta capillary tube in opposite directions to prepare an at least partially closed capillary tube; and
contacting an electrolyte and a tip of the at least partially closed capillary tube,
wherein the electrolyte is in contact with the first electrode and the second electrode, and is exposed to an outer surface of the gas sensor.
